(19) United States
(12) Patent Application Publication
(10) Pub. No.: US 2020/0165476 A1
(43) Pub. Date: May 28, 2020

(54) AQUEOUS PIGMENT DISPERSION

(71) Applicant: DIC Corporation, Tokyo (JP)

(72) Inventors: Atsuo Kobayashi, Kita-adachi-gun (JP); Takaaki Nabe, Kita-adachi-gun (JP); Yoshihiro Sato, Kita-adachi-gun (JP)

(73) Assignee: DIC Corporation, Tokyo (JP)

(21) Appl. No.: 16/618,878

(22) PCT Filed: Jun. 7, 2018
(86) PCT No.: PCT/JP2018/021825

§ 371 Date: Dec. 3, 2019

(30) Foreign Application Priority Data
Jun. 22, 2017 (JP) 2017-122207

(51) Int. Cl. C09D 11/326; C09D 17/00; C09D 7/45; C09D 7/65; C09D 11/037; C09D 11/033; C09D 11/107

(52) U.S. Cl. CPC C09D 11/326; C09D 17/001; C09D 17/005; C09D 11/107; C09D 7/65; C09D 11/037; C09D 11/033; C09D 7/45

(57) ABSTRACT

A problem to be solved by the present invention is to provide an aqueous pigment dispersion for adjustment of ink for ink jet recording in which the optical density OD of plain paper and the gloss value of photographic paper are compatible with each other at a high level. Another object of the present invention is to provide an ink for ink jet recording obtained by using the aqueous pigment dispersion. The present invention relates to an aqueous pigment dispersion including an aqueous medium, a dispersion (A), and a dispersion (B), wherein the dispersion (A) contains a pigment (a) and a pigment dispersant resin, and has a volume average particle diameter of 40 nm or more and less than 70 nm, and wherein the dispersion (B) contains a self-dispersing pigment (b), and has a volume average particle diameter of 70 nm or more and 210 nm or less.

### TECHNICAL FIELD

The present invention relates to an aqueous pigment dispersion which can be used for the production of various inks, such as ink jet recording inks.

### BACKGROUND ART

Ink used in the printing method of the ink jet recording method is required to have low viscosity, hardly cause precipitation or aggregation even if it is not used for a long time, and be hardly clogged in the leading end portion of the head of the ink jet printer and in the ink flow path, and it is required to be capable of producing a printed matter having high optical density and excellent print quality when printing is performed on a recording medium such as plain paper.

As the ink usable for printing on the plain paper, for example, there is known an ink containing a first pigment and a second pigment dispersed in an aqueous medium as a coloring material, wherein the first pigment is a self-dispersing pigment in which at least one anionic group is bonded to the surface of the first pigment directly or via another atomic group, or a self-dispersing pigment in which at least one cationic group is bonded to the surface of the first pigment directly or via another atomic group, the second pigment is a pigment which can be dispersed in the aqueous medium by a polymeric dispersant, and the ink further contains at least one of a polymeric dispersant having the same polarity as that of the group bonded to the surface of the first pigment and a nonionic polymeric dispersant (see, for example, PTL 1).

On the other hand, as an ink jet recording medium, various types of media other than the plain paper as described above are known, and for example, photo paper (photographic paper) may be used in a printing scene such as a photograph.

However, in the ink described in PTL 1, there has been a problem that when printing is performed on photo paper (photographic paper), a printed matter having high gloss cannot be obtained.

### CITATION LIST

### Patent Literature

PTL 1: JP-A-2000-239589

### SUMMARY OF INVENTION

### Technical Problem

A problem to be solved by the present invention is to provide an aqueous pigment dispersion which can be used in the production of an ink that can produce a printed matter having high optical density by printing on plain paper and that can obtain a printed matter having a high gloss value by printing on photo paper (photographic paper).

### Solution to Problem

The present inventors have solved the above-mentioned problem with an aqueous pigment dispersion including an aqueous medium, a dispersion (A), and a dispersion (B), wherein the dispersion (A) contains a pigment (a) and a pigment dispersant resin, and has a volume average particle diameter of 40 nm or more and less than 70 nm, and wherein the dispersion (B) contains a self-dispersing pigment (b), and has a volume average particle diameter of 70 nm or more and 210 nm or less.

### Advantageous Effects of Invention

The aqueous pigment dispersion according to the present invention can be used in the production of an ink that can produce a printed matter having high optical density by printing on plain paper and that can obtain a printed matter having a high gloss value by printing on photo paper (photographic paper).

### DESCRIPTION OF EMBODIMENTS

The aqueous pigment dispersion of the present invention is an aqueous pigment dispersion including an aqueous medium, a dispersion (A), and a dispersion (B), wherein the dispersion (A) contains a pigment (a) and a pigment dispersant resin, and has a volume average particle diameter of 40 nm or more and less than 70 nm, and wherein the dispersion (B) contains a self-dispersing pigment (b), and has a volume average particle diameter of 70 nm or more and 210 nm or less.

As the aqueous pigment dispersion of the present invention, it is preferable to use an aqueous pigment dispersion containing the dispersion (A) in an amount of 20% by mass to 80% by mass with respect to the total amount of the aqueous pigment dispersion, and it is more preferable to use an aqueous pigment dispersion containing the dispersion (A) in an amount of 30% by mass to 80% by mass, because it is possible to obtain a printed matter in which a printed image or the like with higher gloss is formed on photo paper (photographic paper).

In addition, as the aqueous pigment dispersion of the present invention, it is preferable to use an aqueous pigment dispersion containing the dispersion (B) in an amount of 20% by mass to 80% by mass with respect to the total amount of the aqueous pigment dispersion, and it is more preferable to use an aqueous pigment dispersion containing the dispersion (B) in an amount of 30% by mass to 70% by mass, from the viewpoint of obtaining an aqueous pigment dispersion that can be used for the production of an ink capable of producing a printed matter having a high optical density when printed on plain paper.

In addition, as the aqueous pigment dispersion of the present invention, it is preferable to use an aqueous pigment dispersion having a mass ratio of the dispersion (A) to the dispersion (B) [dispersion (A)/dispersion (B)] in the range of 0.25 to 4.0, and it is more preferable to use an aqueous pigment dispersion having the mass ratio in the range of 0.4 to 2.3, from the viewpoint of obtaining an aqueous pigment dispersion that can be used for the production of an ink capable of producing a printed matter having a high optical density when printed on plain paper.

As the dispersion (A), one containing a pigment (a) and a pigment dispersant resin is used. Specifically, as the dispersion (A), a dispersion in which the pigment dispersant resin is adsorbed on the surface of the pigment (a) or the pigment (a) is encapsulated in the pigment dispersant resin to impart dispersibility to an aqueous medium is used. The pigment (a), unlike the self-dispersing pigment (b) described later, requires a pigment dispersant resin in order to be stably dispersed in an aqueous medium.

As the dispersion (A), a dispersion having a volume average particle diameter of 40 nm or more and less than 70 nm is used, and a dispersion having a volume average particle diameter of 40 nm or more and 60 nm or less is preferably used. Here, in the ink using an aqueous pigment dispersion in which instead of the dispersion (A), a dispersion having a volume average particle diameter outside the above range is used in combination with a dispersion (B) to be described later, when printed on photo paper (photographic paper), the surface of the printed image may not be smooth and a high gloss printed image may not be formed.

In the present invention, by using an aqueous pigment dispersion containing the dispersion (A) having a volume average particle diameter in the above range and a dispersion (B) to be described later in combination, a printed matter having a high gloss can be obtained when printing is performed on photo paper (photographic paper).

As described in the examples in the description, the volume average particle diameter was measured three times by detecting scattered light of laser light in an environment of 25° C. using a nanotrack particle size distribution analyzer “UPA150” manufactured by MicrotracBEL Corp., the average value thereof was calculated, and the value obtained by rounding off the first decimal place of the average value was defined as the volume average particle diameter value (unit: nm) according to the matters used to specify the present invention.

As the pigment (a), for example, when producing black ink, carbon black can be used, and #2600 series, #2300 series, #1000 series, #900 series, #600 series, #90 series, and MA series manufactured by Mitsubishi Chemical Corporation, COLOR-BLACK series, SPESIAL-BLACK series, PRINTEX series, HIBLACK series, NEROX series, and NIPex series manufactured by Orion Engineered Carbons, SUNBLACK series, #70 series, and #80 series manufactured by Asahi Carbon Co., Ltd., and TOKA BLACK #7000 series and #8000 series manufactured by Tokai Carbon Co., Ltd. can be used.

Among these, as the carbon black, it is preferable to use an acidic carbon black because the carbon black can produce a printed matter having high optical density when printed on plain paper, and is easy to disperse in an aqueous medium. As the acidic carbon black, it is preferable to use carbon black having a pH of 4.5 or less, such as MA series, #900 series, and #2300 series manufactured by Mitsubishi Chemical Co., Ltd., NEROX 600 and NIPex160IQ manufactured by Orion Engineered Carbons, and SUNBLACK-X series manufactured by Asahi Carbon Co., Ltd.

Specific examples of pigments used in yellow ink include C.I. Pigment Yellow 1, 2, 12, 13, 14, 16, 17, 73, 74, 75, 83, 93, 95, 97, 98, 109, 110, 114, 120, 128, 129, 138, 150, 151, 154, 155, 174, 180, and 185.

Specific examples of pigments used in magenta ink include C.I. Pigment Red 5, 7, 12, 48(Ca), 48(Mn), 57(Ca), 57:1, 112, 122, 123, 146, 168, 176, 184, 185, 202, and 209.

Specific examples of pigments used in cyan ink include C.I. Pigment Blue 1, 2, 3, 15, 15:3, 15:4, 16, 22, 60, 63, and 66.

As the pigment (a), it is preferable to use a pigment having a primary particle diameter in the range of 10 nm to 30 nm, and it is more preferable to use a pigment having a primary particle diameter in the range of 15 nm to 25 nm from the viewpoint of obtaining a printed matter having a high gloss when printed on photo paper (photographic paper).

The primary particle diameter D (nm) of the pigment (a) and the self-dispersing pigment (b) in the present invention is a value obtained in the following manner. First, an aqueous pigment dispersion having a pigment concentration of 1% by mass was dropped into a mesh with a collodion membrane, followed by drying. The surface was observed using a STEM (scanning transmission electron microscope) (JSM-7500FA manufactured by JEOL). The acceleration voltage was set to 30 kV, and the observation magnification was set to a magnification that was easy to observe depending on the observation sample in the range of 5,000 to 200,000 times. Based on the image observed by the above method, a value obtained by measuring the particle diameter (primary particle diameter) of the minimum unit forming the pigment (a) and the self-dispersing pigment (b) at 100 points and averaging it was defined as the primary particle diameter D (nm) according to the present invention.

As the pigment dispersant resin used for dispersing the pigment (a) in the aqueous medium, for example, a polyvinyl resin having an anionic group, a polyester resin having an anionic group, an amino resin having an anionic group, an acrylic resin having an anionic group, an epoxy resin having an anionic group, a polyurethane resin having an anionic group, a polyether resin having an anionic group, a polyamide resin having an anionic group, an unsaturated polyester resin having an anionic group, a phenolic resin having an anionic group, a silicone resin having an anionic group, and a fluorine-based resin having an anionic group can be used.

Among these, it is preferable to use an acrylic resin having an anionic group or a polyurethane resin having an anionic group as the pigment dispersant resin, from the viewpoint of obtaining an aqueous pigment dispersion which is easy to adsorb onto the pigment (a) and which is more excellent in dispersion stability.

As the acrylic resin having an anionic group, a resin obtained by polymerizing a monomer component containing, for example, a monomer having an anionic group and, if necessary, other ethylenically unsaturated monomers can be used. Specifically, it is preferable to use a styrene-(meth)acrylic acid copolymer, a styrene-(meth)acrylic acid ester-(meth)acrylic acid copolymer, a (meth)acrylic acid ester-(meth)acrylic acid copolymer or the like as the acrylic resin having an anionic group.

Examples of the monomer having an anionic group which can be used for producing the acrylic resin having an anionic group include acrylic acid and methacrylic acid, and these monomers can be used singly or in combination of two or more.

As the acrylic resin having an anionic group, it is preferable to use a polymer obtained by polymerizing styrene and acrylic acid and methacrylic acid, from the viewpoint of obtaining an aqueous pigment dispersion excellent in dispersion stability and storage stability.

As other ethylenically unsaturated monomers which can be used for producing the acrylic resin having an anionic group, for example, alkyl styrenes such as styrene, α-methylstyrene, β-methylstyrene, 2,4-dimethylstyrene, α-ethylstyrene, α-butylstyrene and α-hexyl styrene, halogenated styrenes such as 4-chlorostyrene, 3-chlorostyrene and 3-bromostyrene, and styrenic monomers such as 3-nitrostyrene, 4-methoxystyrene and vinyl toluene, and (meth)acrylic acid ester monomers having an aromatic cyclic structure such as benzyl (meth)acrylate, phenyl (meth)acrylate, phenylethyl (meth)acrylate, phenylpropyl (meth)acrylate and phenoxyethyl (meth)acrylate can be used.

Among these, it is particularly preferable to use styrene, α-methylstyrene, and tert-butyl styrene as the ethylenically unsaturated monomer.

As the ethylenically unsaturated monomer, in addition to those described above, acrylic acid esters or methacrylic acid esters such as methyl acrylate, methyl methacrylate, n-propyl acrylate, isopropyl acrylate, n-butyl acrylate, sec-butyl acrylate, tert-butyl acrylate, 2-ethylbutyl acrylate, 1,3-dimethylbutyl acrylate, hexyl acrylate, 2-ethylhexyl acrylate, octyl acrylate, ethyl methacrylate, n-butyl methacrylate, 2-methylbutyl methacrylate, pentyl methacrylate, heptyl methacrylate, and nonyl methacrylate; acrylic acid ester derivatives or methacrylic acid ester derivatives such as 3-ethoxypropyl acrylate, 3-ethoxybutyl acrylate, dimethylaminoethyl acrylate, 2-hydroxyethyl acrylate, 2-hydroxybutyl acrylate, ethyl-α-(hydroxymethyl)acrylate, dimethylaminoethyl methacrylate, hydroxyethyl methacrylate, and hydroxypropyl methacrylate; acrylic acid aryl esters or acrylic acid aralkyl esters such as phenyl acrylate, benzyl acrylate, phenyl ethyl acrylate and phenyl ethyl methacrylate; monoacrylic acid esters or monomethacrylic acid esters of polyhydric alcohols such as diethylene glycol, triethylene glycol, polyethylene glycol, glycerol and bisphenol A; dialkyl esters of maleic acid such as dimethyl maleate and diethyl maleate, and vinyl acetate and the like can be used.

As the pigment dispersant resin, a polymer from a monomer having one ethylenically unsaturated group (linear polymer) or a polymer from a monomer having one ethylenically unsaturated group and a monomer having two or more ethylenically unsaturated groups can be used.

As the monomer having two or more ethylenically unsaturated groups, for example, glycidyl (meth)acrylate, divinylbenzene, and a poly (meth)acrylate of a polyhydric alcohol such as ethylene glycol di(meth)acrylate, propylene glycol di(meth)acrylate, polyethylene glycol di(meth)acrylate, poly(oxyethylene oxypropylene) glycol di(meth)acrylate, and a tri(meth)acrylate of an alkylene oxide adduct of glycerin can be used.

When the styrene-acrylic acid copolymer is used as the pigment dispersant resin, the use ratio of styrene with respect to the total amount of the monomer components used in the preparation is more preferably 50% by mass to 90% by mass, and particularly preferably 70% by mass to 90% by mass from the viewpoints of easily adjusting the volume average particle diameter of the dispersion (A) within the range described above and obtaining an ink usable for producing a printed matter having a higher gloss when printed on photo paper (photographic paper).

When the styrene-acrylic acid copolymer is used as the pigment dispersant resin, the ratio of the total mass of the styrene, acrylic acid and methacrylic acid with respect to the total amount of the monomer components used in the preparation is preferably 80% by mass or more, and more preferably 95% by mass to 100% by mass from the viewpoint of imparting better dispersion stability to the pigment (a).

As a method for producing the pigment dispersant resin, for example, a bulk polymerization method, a solution polymerization method, a suspension polymerization method, an emulsion polymerization method, or the like can be employed in the case where the acrylic resin having an anionic group is used. When the pigment dispersant resin is produced, a polymerization catalyst, a chain transfer agent (polymerization degree adjusting agent), a surfactant, an antifoaming agent, and the like may be used as necessary.

As the polymerization catalyst, for example, 2,2′-azobis(2,4-dimethylvaleronitrile), 2,2′-azobisisobutyronitrile, 1,1′-azobis(cyclohexane-1-carbonitrile), benzoyl peroxide, dibutyl peroxide, butyl peroxybenzoate and the like can be used. The polymerization catalyst is preferably used in an amount of 0.1% by mass to 10.0% by mass with respect to the total amount of the monomer components used in the preparation of the acrylic resin having an anionic group.

As the pigment dispersant resin, those having a weight average molecular weight in the range of 6000 to 25000 are preferably used, those having a weight average molecular weight in the range of 6000 to 20000 are more preferably used, and those having a weight average molecular weight in the range of 6000 to 15000 are particularly preferably used from the viewpoints of suppressing an increase in the viscosity of the aqueous pigment dispersion of the present invention and imparting further excellent dispersion stability and storage stability. Here, the weight average molecular weight is a value measured by a GPC (gel Permeation chromatography) method, and is a value calculated in terms of the molecular weight of polystyrene used as a standard material.

As the pigment dispersant resin, those having an acid value of 50 to 220 (mgKOH/g) are preferably used, those having an acid value of 70 to 200 (mgKOH/g) are more preferably used, and those having an acid value of 80 to 180 (mgKOH/g) are particularly preferably used from the viewpoints of obtaining excellent dispersion stability of the dispersion (A) and excellent storage stability of the aqueous pigment dispersion, and producing a printed matter having high optical density and excellent water resistance when printed on plain paper.

The acid value referred to herein is a numerical value measured in accordance with the Japanese Industrial Standard “K0070:1992. Test Method for Acid Value, Saponification Value, Ester Value, Iodine Value, Hydroxyl Value and Unsaponified Product of Chemical Products”, and is the amount (mg) of potassium hydroxide necessary for completely neutralizing 1 g of resin.

When a pigment dispersant resin having an anionic group such as a carboxyl group is used as the pigment dispersant resin, it is preferable that the anionic group is neutralized by a basic compound.

As the basic compound, for example, hydroxides of alkali metals such as potassium and sodium; carbonates of alkali metals such as potassium and sodium; carbonates of alkaline earth metals such as calcium and barium; inorganic basic compounds such as ammonium hydroxide; and organic basic compounds such as amino alcohols such as triethanolamine, N,N-dimethanolamine, N-aminoethylethanolamine, dimethylethanolamine, and N-N-butyldiethanolamine, morpholines such as morpholine, N-methylmorpholine, and N-ethylmorpholine, piperazines such as N-(2-hydroxyethyl) piperazine and piperazine hexahydrate can be used. Among these, as the basic compound, it is more preferable to use hydroxides of alkali metals typified by potassium hydroxide, sodium hydroxide, and lithium hydroxide, especially potassium hydroxide, from the viewpoints of suppressing an increase in the viscosity of the aqueous pigment dispersion and obtaining the aqueous pigment dispersion which can be used for the production of an aqueous ink for ink jet recording which is excellent in ejection stability.

As the dispersion (A), as a raw material for producing the aqueous pigment dispersion of the present invention, it is preferable to use a dispersion liquid in which the pigment (a) is previously dispersed in an aqueous medium by a pigment dispersant resin (that is, a dispersion liquid in which the dispersion (A) is dispersed in an aqueous medium) from the viewpoints of easily controlling the volume average particle diameter of the dispersion (A) within the range described above, being excellent in dispersion stability, and obtaining an aqueous pigment dispersion which can be used for the production of an ink usable for producing a printed matter having a higher gloss and excellent scratch resistance when printed on photo paper (photographic paper).

The dispersion (A) in the dispersion liquid is preferably a dispersion (A) in a state in which the pigment dispersant resin is adsorbed on the surface of the pigment (a) or in a state in which the pigment (a) is encapsulated in the pigment dispersant resin.

Next, the dispersion (B) used in the present invention will be described.

As the dispersion (B), a dispersion containing a self-dispersing pigment (b) and having a volume average particle diameter of 70 nm or more and 210 nm or less is used.

As the dispersion (B), a dispersion having a volume average particle diameter of 70 nm or more and 210 nm or less, preferably 100 nm or more and 200 nm or less, more preferably 120 nm or more and 190 nm or less, and particularly preferably 120 nm or more and less than 170 nm is used.

Here, in the aqueous pigment dispersion containing only one of the dispersion (A) and the dispersion (B), the above-mentioned problem cannot be solved. By using the aqueous pigment dispersion containing the dispersion (A) and the dispersion (B) in combination, it is possible to obtain an aqueous pigment dispersion which can be used in the production of an ink that can produce a printed matter having high optical density by printing on plain paper and that can obtain a printed matter having a high gloss value by printing on photo paper (photographic paper).

Since the self-dispersing pigment (b) constituting the dispersion (B) has good dispersibility in an aqueous medium, it is not necessary to use a pigment dispersant resin as used in the dispersion (A). As the self-dispersing pigment (b), a pigment in which a functional group capable of imparting water dispersibility to a surface of the pigment is introduced may be used. As the self-dispersing pigment (b), for example, in the case of a self-dispersing black pigment, one in which at least one functional group selected from the group consisting of a carbonyl group, a carboxyl group, a hydroxyl group, a sulfone group and a salt of these functional groups is bonded to a surface of a carbon black is exemplified.

In the case of a black pigment, the self-dispersing pigment (b) used in the present invention may be, for example, self-dispersing carbon black, and furnace black, lamp black, acetylene black, channel black and the like can be used.

As the self-dispersing carbon black, for example, commercially available products such as Raven 7000, Raven 5750, Raven 5250, Raven 5000ULTRA, Raven 3500, Raven 2000, Raven 1500, Raven 1250, Raven 1200, Raven 1190ULTRA-II, Raven 1170, Raven 1255 (manufactured by Colombia); Black Pearls L, Regal 400R, Regal 330R, Regal 660R, Mogul L, Monarch 700, Monarch 800, Monarch 880, Monarch 900, Monarch 1000, Monarch 1100, Monarch 1300, Monarch 1400, Monarch 2000, Vulcan XC-72R (manufactured by Cabot); Color Black FW1, Color Black FW2, Color Black FW2V, Color Black FW18, Color Black FW200, Color Black S150, Color Black S160, Color Black $170, Printex 35, Printex U, Printex V, Printex 140U, Printex 140V, Special Black 6, Special Black 5, Special Black 4A, Special Black 4 (manufactured by Degussa); and No. 25, No. 33, No. 40, No. 47, No. 52, No. 900, No. 960, No. 2300, MCF-88, MA600, MA7, MA8, MA14, MA77, MA100, MA220 (manufactured by Mitsubishi Chemical Corporation) can be used.

The primary particle diameter of the self-dispersing pigment (b) used is preferably in the range of 10 nm to 30 nm, and particularly preferably in the range of 15 nm to 30 nm from the viewpoint of obtaining an aqueous pigment dispersion which can be used in an ink that can produce a printed matter having high optical density in a case of printing on plain paper and that can be used for the production of a printed matter having a higher gloss in a case of printing on photo paper (photographic paper).

The ratio of the primary particle diameter of the pigment (a) to the primary particle diameter of the self-dispersing pigment (b) (primary particle diameter of the pigment (a)/primary particle diameter of the self-dispersing pigment (b)) is preferably in the range of 0.5 to 1.5, and particularly preferably in the range of 0.6 to 1.4 from the viewpoint of obtaining an aqueous pigment dispersion which can be used in an ink that can produce a printed matter having high optical density in a case of printing on plain paper and that can be used for the production of a printed matter having a higher gloss in a case of printing on photo paper (photographic paper).

As the dispersion (B), for example, “CAB-O-JET200”, “CAB-O-JET250C”, “CAB-O-JET260M”, “CAB-O-JET270Y”, “CAB-O-JET300”, “CAB-O-JET400”, “CAB-O-JET450C”, “CAB-O-JET465M” and “CAB-O-JET470Y” manufactured by Cabot Specialty Chemicals; “BONJET BLACK CW-2” and “BONJET BLACK CW-3” manufactured by Orient Chemical Industries Co., Ltd.; and “LIOJET WD BLACK 002C” manufactured by Toyo Ink SC Holdings Co., Ltd. can be used.

In addition, as the dispersion (B), a dispersion in which the dispersion (B) is previously dispersed in an aqueous medium can be used, and for example, “SENSIJJET Black SDP100”, “SENSIJJET Black SDP1000”, “SENSIJJET Black SDP2000”, “Sensijet Ultra Yellow PY74”, “Sensijet Ultra Magenta PR122”, “Sensijet Ultra Cyan PB15:4”, and “Sensijet Ultra K” manufactured by Sensient Colors Inc. can be used.

The self-dispersing pigment (b) can be produced, for example, by introducing a functional group capable of imparting water dispersibility to the surface of the pigment.

Examples of the method for introducing the functional group include a method using ammonium peroxodisulfate, hydrogen peroxide, ozone, oxygen (pure oxygen or air containing oxygen), potassium bromate, and sodium perborate, and the like.

As the self-dispersing pigment (b), it is preferable to use a dispersion liquid previously dispersed in an aqueous medium (i.e., a dispersion liquid in which the dispersion (B) is dispersed in an aqueous medium) as a raw material for producing the aqueous pigment dispersion of the present invention.

Next, a method for producing the aqueous pigment dispersion of the present invention will be described.

The aqueous pigment dispersion can be produced, for example, by separately preparing the dispersion (A) and the dispersion (B) and supplying them to an aqueous medium to be mixed therewith.

Further, the aqueous pigment dispersion may be produced by mixing a dispersion liquid in which the dispersion (A) containing a pigment (a) and a pigment dispersant resin prepared in advance is dispersed in an aqueous medium with a dispersion (B) containing the self-dispersing pigment (b) or a dispersion liquid in which the dispersion (B) is dispersed in an aqueous medium. When the aqueous pigment dispersion is produced, a foreign substance may be removed by subjecting the aqueous pigment dispersion to a filtration treatment, if necessary, after the mixture is mixed.

First, a method for producing a dispersion liquid in which the dispersion (A) is dispersed in an aqueous medium will be described.

The dispersion liquid in which the dispersion (A) containing the pigment (a) and the pigment dispersant resin is dispersed in an aqueous medium can be produced by, for example, kneading a mixture containing the pigment (a), the pigment dispersant resin, a basic compound, and if necessary, an aqueous medium, to obtain a kneaded product, and mixing the kneaded product and an aqueous medium or the like.

The mixture can be prepared by mixing the pigment (a), the pigment dispersant resin, and if necessary, a basic compound, a wetting agent and water. It is preferable that the mixture is prepared by previously mixing the pigment (a) and the pigment dispersant resin in a powder form, and then mixing the mixture with a basic compound or a wetting agent or water, if necessary, from the viewpoint of achieving both excellent dispersion stability of the dispersion (A) and excellent storage stability of the aqueous pigment dispersion.

As the mixture, the total mass of the pigment (a) and the pigment dispersant resin with respect to the total amount of the mixture is preferably in the range of 50% by mass to 80% by mass, and more preferably in the range of 60% by mass to 80% by mass.

In addition, as the mixture, it is preferable to use one in which the mass ratio of the pigment (a) and the pigment dispersant resin (mass of pigment dispersant resin/mass of pigment (a)) is 1.0 or less, more preferably 0.5 or less, and still more preferably 0.4 or less, so that the primary particle diameter of the dispersion (A) can be adjusted to the above-described range and it is less likely to cause a noticeable ink ejection failure when used for producing an ink for ink jet recording.

Examples of the method of kneading the mixture include a method using a pressure kneader, a Henschel mixer or a planetary mixer, and the use of a pressure kneader or a planetary mixer is preferable from the viewpoint of achieving both excellent dispersion stability of the dispersion (A) and excellent storage stability of the aqueous pigment dispersion.

As a method for mixing the kneaded product obtained through the kneading step and the aqueous medium or the like, there may be mentioned a method in which an aqueous medium is supplied to the kneaded product to be stirred. For example, the mixing method may be a method of repeatedly supplying and stirring an aqueous medium or the like to the kneaded product obtained through the kneading step, preferably having a solid content concentration of 50% by mass to 80% by mass.

As the dispersion liquid in which the dispersion (A) obtained by the above method is dispersed in an aqueous medium, a dispersion liquid having a solid content concentration of 20% by mass to 35% by mass can be used.

When coarse particles of the dispersion (A) are contained in a dispersion liquid in which the dispersion (A) is dispersed in an aqueous medium, it is preferable to remove coarse particles by subjecting the dispersion (A) to centrifugal separation or filtration, if necessary, from the viewpoint of obtaining an ink which can suppress the occurrence of ink clogging in the ink ejection nozzle, and which can be used for producing a printed matter having a higher gloss when printed on photo paper (photographic paper).

Next, a method for producing a dispersion liquid in which the dispersion (B) is dispersed in an aqueous medium will be described.

The dispersion liquid in which the dispersion (B) containing the water-dispersing pigment (b) is dispersed in an aqueous medium can be produced, for example, by mixing a water-dispersing pigment (b) and an aqueous medium. The mixing may be carried out by a medialess dispersing method as necessary.

Specific examples of the medialess dispersing method include an ultrasonic dispersion method, and a dispersion method using a high-speed disk impeller, a colloid mill, a roll mill, a high-pressure homogenizer, a nanomizer, an ultimizer, and the like. Hereinafter, the ultrasonic dispersion method will be described in detail.

First, the water-dispersing pigment (b) and the aqueous medium are previously mixed and stirred to prepare a mixture.

The mixture preferably has adequate fluidity in order to facilitate the production of the ink by diluting with an aqueous medium, and preferably has a viscosity in the range of 0.1 mPa·s to 100 mPa·s, and most preferably in the range of 0.5 mPa·s to 10 mPa·s.

The mixture for use preferably has a water-dispersing pigment (b) concentration in the range of 5% by mass to 30% by mass, more preferably in the range of 10% by mass to 20% by mass, with respect to the total amount of the mixture.

Then, the mixture obtained above is irradiated with ultrasonic waves.

The irradiation condition of the ultrasonic wave is not particularly limited, but it is preferably performed at an output of 200 W to 3000 W and a frequency of 15 kHz to 40 kHz, and more preferably at an output of 500 W to 2000 W and a frequency of 15 kHz to 25 kHz.

The time for performing the ultrasonic irradiation is suitably such that an electric power of 0.5 W/g to 2.0 W/g is given with respect to the mass of the self-dispersing pigment (b) contained in the dispersion liquid in which the dispersion (B) is dispersed in an aqueous medium.

When coarse particles of the dispersion (B) are contained in the dispersion liquid in which the dispersion (B) is dispersed in an aqueous medium, it is preferable to remove coarse particles by subjecting the dispersion (B) to a centrifugal separation treatment or a filtration treatment, if necessary, from the viewpoint of obtaining an ink which can suppress the occurrence of ink clogging in the ink ejection nozzle, and which can be used for producing a printed matter having a higher gloss when printed on photo paper (photographic paper).

The dispersion liquid in which the dispersion (B) is dispersed in the aqueous medium preferably contains a resin having an anionic group, a basic compound, or the like as necessary, from the standpoints of obtaining more excellent dispersion stability of the dispersion (B), and further improving adhesiveness of the ink to the recording medium, and scratch resistance of a printed matter. Specifically, as the dispersion liquid, a composition containing the resin having an anionic group, a basic compound and water is prepared in advance, and the composition is supplied to a dispersion liquid to be mixed therewith, and then the obtained product may be used.

The composition is preferably added to the dispersion liquid prepared in advance. Accordingly, aggregation or the like of the dispersions (B) can be effectively suppressed, and more excellent storage stability can be imparted to the aqueous pigment dispersion.

For example, in a case of using an acidic carbon black as the self-dispersing pigment (b), when the acidic carbon black and the resin having an anionic group or the like are mixed together, aggregation due to the acid derived from the carbon black and the anionic group possessed by the resin may be easily generated. Therefore, it is preferable that the composition containing the resin having an anionic group or the like is supplied to and mixed with a dispersion liquid in which the acidic carbon is dispersed in an aqueous medium in advance.

As the resin having an anionic group, for example, a polyvinyl resin having an anionic group, a polyester resin having an anionic group, an amino resin having an anionic group, an acrylic copolymer having an anionic group, an epoxy resin having an anionic group, a polyurethane resin having an anionic group, a polyether resin having an anionic group, a polyamide resin having an anionic group, an unsaturated polyester resin having an anionic group, a phenolic resin having an anionic group, a silicone resin having an anionic group, and a fluorine-based polymer compound having an anionic group may be used, and it is preferable to use an acrylic copolymer having an anionic group or a polyurethane resin having an anionic group because the raw material is abundant, easy to design, and excellent in pigment dispersion function.

The resin having an anionic group is preferably used in the range of 0.2 parts by mass to 1.0 part by mass with respect to 1 part by mass of the self-dispersing pigment (b).

As the aqueous pigment dispersion of the present invention obtained by the above method, it is preferable to use a dispersion having a solid content of 15% by mass to 30% by mass and a pigment concentration in the range of 10% by mass to 20% by mass from the standpoint of maintaining a more excellent storage stability.

The aqueous pigment dispersion can be used as an ink by diluting to a desired concentration.

Examples of the ink include coating materials for automobiles and building materials, printing inks such as an of f set ink, a gravure ink, a flexographic ink, and a silk screen ink, or ink jet printing inks. When the ink is used in an ink jet recording system, it is preferable that the concentration of the pigment with respect to the total amount of the ink is 1% by mass to 10% by mass.

The ink can be produced by mixing an aqueous pigment dispersion according to the present invention and, if necessary, a solvent such as a water-soluble organic solvent or water, a resin such as an acrylic resin and a polyurethane resin as a binder, and an additive such as a drying inhibitor, a penetrant, a surfactant, an antiseptic, a viscosity adjuster, a pH adjuster, a chelating agent, a plasticizer, an antioxidant, and an ultraviolet absorber. The ink may be subjected to a centrifugal separation treatment or a filtration treatment after being produced by the method described above.

The water-soluble organic solvent can be used to prevent drying of the ink and to adjust the viscosity and concentration of the ink to a suitable range.

The water-soluble organic solvent may be any of those exemplified for use in the production step [1] for the aqueous pigment dispersion. Among them, examples of the water-soluble organic solvent include a lower alcohol such as ethanol and isopropyl alcohol; an ethylene oxide adduct of an alkyl alcohol such as ethylene glycol hexyl ether and diethylene glycol butyl ether; and a propylene oxide adduct of an alkyl alcohol such as propylene glycol propyl ether, from the viewpoint of enhancing the permeability of the ink to the recording medium.

Examples of the drying inhibitor include glycerin, ethylene glycol, diethylene glycol, triethylene glycol, triethylene glycol mono-n-butyl ether, polyethylene glycol having a molecular weight of 2000 or less, propylene glycol, dipropylene glycol, tripropylene glycol, 1,3-propylene glycol, isopropylene glycol, isobutylene glycol, 1,4-butanediol, 1,3-butanediol, 1,5-pentanediol, 1,6-hexanediol, mesoerythritol and pentaerythritol. Among them, glycerin and triethylene glycol is preferably used as the drying inhibitor, from the viewpoint of obtaining an ink that has safety, is hardly dried, and is excellent in ejection performance.

As the drying inhibitor, the same compound as the aforementioned water-soluble organic solvent used in the aqueous pigment dispersion can be used. Therefore, when a water-soluble organic solvent is already used in an aqueous pigment dispersion, it can also serve as a drying inhibitor.

The penetrant can be used for the purpose of improving the permeability to the recording medium and adjusting the dot diameter on the recording medium.

Examples of the penetrant include a lower alcohol such as ethanol and isopropyl alcohol, and a glycol monoether of an alkyl alcohol such as ethylene glycol hexyl ether, diethylene glycol butyl ether, and propylene glycol propyl ether. The content of the penetrant in the ink is preferably 0.01% by mass to 10% by mass.

The surfactant can be used to adjust ink properties such as surface tension. The surfactant is not particularly limited, and examples thereof include various anionic surfactants, nonionic surfactants, cationic surfactants, and amphoteric surfactants, and among these surfactants, anionic surfactants and nonionic surfactants are preferred.

Examples of the anionic surfactant include alkylbenzene sulfonate, alkylphenyl sulfonate, alkylnaphthalene sulfonate, higher fatty acid salt, sulfuric acid ester salt of higher fatty acid ester, sulfonate salt of higher fatty acid ester, sulfuric acid ester salt and sulfonate salt of higher alcohol ether, higher alkyl sulfosuccinate, polyoxyethylene alkyl ether carboxylate, polyoxyethylene alkyl ether sulfate, alkyl phosphate, and polyoxyethylene alkyl ether phosphate, and specific examples thereof include dodecylbenzene sulfonate, isopropylnaphthalene sulfonate, monobutyl phenyl phenol monosulfonate, monobutyl biphenyl sulfonate, and dibutylphenyl phenol disulfonate.

Examples of the nonionic surfactant include polyoxyethylene alkyl ether, polyoxyethylene alkylphenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, sucrose fatty acid ester, polyoxyethylene alkylamine, polyoxyethylene fatty acid amide, fatty acid alkylolamide, alkyl alkanolamide, acetylene glycol, oxyethylene adduct of acetylene glycol, and polyethylene glycol polypropylene glycol block copolymer. Among them, polyoxyethylene nonyl phenyl ether, polyoxyethylene octyl phenyl ether, polyoxyethylene dodecyl phenyl ether, polyoxyethylene alkyl ether, polyoxyethylene fatty acid ester, sorbitan fatty acid ester, polyoxyethylene sorbitan fatty acid ester, fatty acid alkylolamide, acetylene glycol, oxyethylene adduct of acetylene glycol, and polyethylene glycol polypropylene glycol block copolymer are preferred.

As other surfactants, silicone surfactants such as polysiloxane oxyethylene adducts; fluorine-based surfactants such as perfluoroalkyl carboxylates, perfluoroalkyl sulfonates and oxyethylene perfluoroalkyl ethers; and biosurfactants such as spiculisporic acid, rhamnolipid, and lysolecithin can also be used.

The surfactant may be used alone or in combination of two or more. The amount of the surfactant to be used is preferably in the range of 0.001% by mass to 2% by mass, more preferably 0.001% by mass to 1.5% by mass, and still more preferably 0.01% by mass to 1% by mass, with respect to the total mass of the ink, from the viewpoint of more effectively preventing bleeding of the printed image.

The ink obtained by the above method can be suitably used as an ink for ink jet recording. Examples of the ink jet recording method include a continuous injection type (a charge control type and a spray type), and an on-demand type (a piezo type, a thermal type, and an electrostatic attraction type). Among these, a printing method and a method for producing a printed matter in which an ink jet recording method in a single-pass system using a line head which generally tends to cause deterioration in image quality due to clogging or the like of an ejection nozzle as compared with the ink jet printing method in a multi-pass system (scanning system) is selected as the ink jet recording method and used in combination with the ink of the present invention are preferable from the viewpoint of obtaining a printed matter in which the deterioration in image quality due to clogging or the like of the ejection nozzle is hardly caused and the occurrence of streaks or the like is suppressed.

### (Recording Medium)

By using the ink obtained using the aqueous pigment dispersion of the present invention, a printed matter having high optical density can be obtained by printing on plain paper and a printed matter having a high gloss value can be obtained by printing on photo paper (photographic paper).

Examples of the plain paper include Canon plain paper (white, white double-sided thick paper, business), EPSON plain paper (Epson genuine double-sided high-quality plain paper, KA4500 BZ, high-quality plain paper, Epson double-sided high-quality plain paper (recycled paper)), plain paper High-White, Elecom plain paper, and ink jet paper, and mat paper.

Examples of the photo paper (photographic paper) include Canon photo paper (glossy pro (platinum grade), glossy gold, glossy standard, fine grained glossy raster), Epson photo paper (CRISPIA, Photo Mat Paper, Super fine paper, premium photo paper, etc.), and HP Advanced Photo Paper, and HP Brochure Paper.

### EXAMPLES

Hereinafter, the present invention will be described based on examples.

A polymer (weight average molecular weight: 8000, acid value: 150 mgKOH/g, glass transition point: 111° C.) composed of 77 parts by mass of styrene, 13 parts by mass of methacrylic acid, and 10 parts by mass of acrylic acid was used as a pigment dispersant resin A.

### (Preparation of Dispersion Liquid (A-1))

50 parts by mass of #2650 (manufactured by Mitsubishi Chemical Corporation, carbon black), 15 parts by mass of a pigment dispersant resin A, 6.6 parts by mass of a 34% by mass potassium hydroxide aqueous solution and 33 parts by mass of diethylene glycol were charged into a planetary mixer (ACM04LVTJ-B manufactured by AICOHSHA MFG. CO., LTD.) and kneaded for 60 minutes at a jacket temperature of 60° C. and a stirring blade rotation speed of 25 rpm (revolution speed of 80 rpm) to obtain a kneaded product.

Then, the kneaded product was charged into a mixer (Healthy Mix, manufactured by ZOJIRUSHI CORPORATION), ion-exchanged water was added to the mixture, and the mixture was sealed and stirred for 20 minutes, thereby obtaining a dispersion liquid (A-1) having a pigment concentration of 12% by mass and containing a dispersion (A-1) having a volume average particle diameter of 41 nm.

### (Preparation of Dispersion Liquid (A-2))

A dispersion liquid (A-2) having a pigment concentration of 12% by mass and containing a dispersion (A-2) having a volume average particle diameter of 53 nm was obtained in the same manner as in Example 1 except that #2300 (manufactured by Mitsubishi Chemical Corporation, carbon black) was used instead of #2650 (manufactured by Mitsubishi Chemical Corporation, carbon black) in an amount of 50 parts by mass.

### (Preparation of Dispersion Liquid (A-3))

A dispersion liquid (A-3) having a pigment concentration of 12% by mass and containing a dispersion (A-3) having a volume average particle diameter of 69 nm was obtained in the same manner as in Example 1 except that #650B (manufactured by Mitsubishi Chemical Corporation, carbon black) was used instead of #2650 (manufactured by Mitsubishi Chemical Corporation, carbon black) in an amount of 50 parts by mass.

### (Preparation of Dispersion Liquid (A-4))

A dispersion liquid (A-4) having a pigment concentration of 12% by mass and containing a dispersion (A-4) having a volume average particle diameter of 120 nm was obtained in the same manner as in Example 1 except that #85 (manufactured by Mitsubishi Chemical Corporation, carbon black) was used instead of #2650 (manufactured by Mitsubishi Chemical Corporation, carbon black) in an amount of 50 parts by mass.

(Preparation of Self-Dispersing Pigment (b-1))

100 parts by mass of NIPex90 (manufactured by Orion Engineered Carbons, carbon black) was charged into 4000 parts by mass of an aqueous solution of sodium peroxodisulfate (concentration: 1.5 mol/L), and the mixture was stirred under conditions of a temperature of 85° C. and a stirring speed of 0.12 rotations/s to carry out an oxidation treatment.

Then, the oxidized product was filtered. Then, the oxidized carbon black remaining on the filter paper and the dispersion liquid obtained by mixing ion-exchanged water with sodium hydroxide were treated with an ultrafiltration membrane AHP-1010 (manufactured by Asahi Chemical Industry Co., Ltd.), and the oxidized carbon black on the filtration membrane was dried to obtain a self-dispersing pigment (b-1), which was carbon black having a carboxyl group introduced on the surface thereof.

### (Preparation of Styrene-Acrylic Acid Resin Aqueous Solution X)

50 parts by mass of a polymer (weight average molecular weight 8000, acid value 150 mgKOH/g, glass transition point 111° C.) composed of 77 parts by mass of styrene, 13 parts by mass of methacrylic acid and 10 parts by mass of acrylic acid, 50 parts by mass of methyl ethyl ketone, 87.4 parts by mass of ion-exchanged water, and 22 parts by mass of a 34% by mass potassium hydroxide aqueous solution were mixed and stirred, and then the methyl ethyl ketone was removed under the conditions of a water bath temperature of 45° C. and a reduced pressure of 40 hPa to obtain a styrene-acrylic acid resin aqueous solution X having a solid content of 20% by mass.

### (Preparation of Dispersion Liquid (B-1))

To a metal beaker, 15 parts by mass of the self-dispersing pigment (b-1), 85 parts by mass of ion-exchanged water and 0.55 parts by mass of a 34% by mass potassium hydroxide aqueous solution were supplied and stirred to obtain a mixture.

Next, the mixture was subjected to ultrasonic dispersing treatment using an ultrasonic dispersing machine described below. The ultrasonic treatment time was 3 minutes. The energy applied to the mixture by the ultrasonic dispersing treatment was adjusted to be 0.7 w/g of the self-dispersing pigment (b-1) 1 g.

Ultrasonic dispersing machine (UP200St manufactured by Hielecher)

Maximum output: 200 W

Frequency: 20 KHz

Then, the dispersion liquid obtained by the ultrasonic dispersing treatment was allowed to stand for 30 minutes. To the dispersion liquid after standing, 15 parts by mass of the styrene-acrylic resin aqueous solution X was added, and sufficiently stirred to adjust the pigment concentration with ion-exchanged water, thereby obtaining a dispersion liquid (B-1) having a pigment concentration of 12% by mass in which a dispersion (B-1) having a volume average particle diameter of 110 nm was dispersed in ion-exchanged water.

(Preparation of Self-Dispersing Pigment (b-2))

A self-dispersing pigment (b-2) was obtained in the same manner as described in “(Preparation of Self-dispersing Pigment (b-1))” except that MA77 (manufactured by Mitsubishi Chemical Corporation, carbon black) was used instead of NIPex90 (manufactured by Orion Engineered Carbons, carbon black).

### (Preparation of Dispersion Liquid (B-2))

A dispersion liquid (B-2) having a pigment concentration of 12% by mass in which a dispersion (B-2) having a volume average particle diameter of 145 nm was dispersed in ion-exchanged water was obtained in the same manner as described in “(Preparation of Dispersion Liquid (B-1))” except that the self-dispersing pigment (b-2) was used instead of the self-dispersing pigment (b-1).

(Preparation of Self-Dispersing Pigment (b-3))

A self-dispersing pigment (b-3) was obtained in the same manner as described in “(Preparation of Self-dispersing Pigment (b-1))” except that NIPex150 (manufactured by Orion Engineered Carbons, carbon black) was used instead of NIPex90 (manufactured by Orion Engineered Carbons, carbon black).

### (Preparation of Dispersion Liquid (B-3))

A dispersion liquid (B-3) having a pigment concentration of 12% by mass in which a dispersion (B-3) having a volume average particle diameter of 170 nm was dispersed in ion-exchanged water was obtained in the same manner as described in “(Preparation of Dispersion Liquid (B-1))” except that the self-dispersing pigment (b-3) was used instead of the self-dispersing pigment (b-1).

(Preparation of Self-Dispersing Pigment (b-4))

A self-dispersing pigment (b-4) was obtained in the same manner as described in “(Preparation of Self-dispersing Pigment (b-1))” except that MA14 (manufactured by Mitsubishi Chemical Corporation, carbon black) was used instead of NIPex90 (manufactured by Orion Engineered Carbons, carbon black).

### (Preparation of Dispersion Liquid (B-4))

A dispersion liquid (B-4) having a pigment concentration of 12% by mass in which a dispersion (B-4) having a volume average particle diameter of 223 nm was dispersed in ion-exchanged water was obtained in the same manner as described in “(Preparation of Dispersion Liquid (B-1))” except that the self-dispersing pigment (b-4) was used instead of the self-dispersing pigment (b-1).

### Example 1

60 parts by mass of the dispersion liquid (A-1) obtained above and 40 parts by mass of the dispersion liquid (B-1) obtained above were mixed, stirred for 10 minutes with a stirrer, and then filtered through a 1.2 μm filter (manufactured by Pall Corporation) to obtain an aqueous pigment dispersion having a pigment concentration of 12% by mass.

### <Method for Producing Aqueous Ink for Ink Jet Recording>

50 parts by mass of the aqueous pigment dispersion, 8 parts by mass of 2-pyrrolidinone, 8 parts by mass of triethylene glycol mono-n-butyl ether, 3 parts by mass of refined glycerin, 0.5 parts by mass of Surfynol 440 (manufactured by Air Products and Chemicals, Inc.), and 30.5 parts by mass of ion-exchanged water were mixed to obtain an aqueous ink for ink jet recording having a pigment concentration of 6% by mass.

### Example 2

An aqueous pigment dispersion and an aqueous ink for ink jet recording were obtained in the same manner as in Example 1 except that 80 parts by mass of the dispersion liquid (A-1) and 20 parts by mass of the dispersion liquid (B-1) were used instead of 60 parts by mass of the dispersion liquid (A-1) and 40 parts by mass of the dispersion liquid (B-1).

### Example 3

An aqueous pigment dispersion and an aqueous ink for ink jet recording were obtained in the same manner as in Example 1 except that 45 parts by mass of the dispersion liquid (A-2) and 55 parts by mass of the dispersion liquid (B-1) were used instead of 60 parts by mass of the dispersion liquid (A-1) and 40 parts by mass of the dispersion liquid (B-1).

### Example 4

An aqueous pigment dispersion and an aqueous ink for ink jet recording were obtained in the same manner as in Example 1 except that 20 parts by mass of the dispersion liquid (A-2) and 80 parts by mass of the dispersion liquid (B-1) were used instead of 60 parts by mass of the dispersion liquid (A-1) and 40 parts by mass of the dispersion liquid (B-1).

### Example 5

An aqueous pigment dispersion and an aqueous ink for ink jet recording were obtained in the same manner as in Example 1 except that 50 parts by mass of the dispersion liquid (A-2) and 50 parts by mass of the dispersion liquid (B-1) were used instead of 60 parts by mass of the dispersion liquid (A-1) and 40 parts by mass of the dispersion liquid (B-1).

### Example 6

An aqueous pigment dispersion and an aqueous ink for ink jet recording were obtained in the same manner as in Example 1 except that 60 parts by mass of the dispersion liquid (A-1) and 40 parts by mass of the dispersion liquid (B-2) were used instead of 60 parts by mass of the dispersion liquid (A-1) and 40 parts by mass of the dispersion liquid (B-1).

### Example 7

An aqueous pigment dispersion and an aqueous ink for ink jet recording were obtained in the same manner as in Example 1 except that 80 parts by mass of the dispersion liquid (A-2) and 20 parts by mass of the dispersion liquid (B-2) were used instead of 60 parts by mass of the dispersion liquid (A-1) and 40 parts by mass of the dispersion liquid (B-1).

### Example 8

An aqueous pigment dispersion and an aqueous ink for ink jet recording were obtained in the same manner as in Example 1 except that 70 parts by mass of the dispersion liquid (A-2) and 30 parts by mass of the dispersion liquid (B-2) were used instead of 60 parts by mass of the dispersion liquid (A-1) and 40 parts by mass of the dispersion liquid (B-1).

### Example 9

An aqueous pigment dispersion and an aqueous ink for ink jet recording were obtained in the same manner as in Example 1 except that 50 parts by mass of the dispersion liquid (A-2) and 50 parts by mass of the dispersion liquid (B-2) were used instead of 60 parts by mass of the dispersion liquid (A-1) and 40 parts by mass of the dispersion liquid (B-1).

### Example 10

An aqueous pigment dispersion and an aqueous ink for ink jet recording were obtained in the same manner as in Example 1 except that 35 parts by mass of the dispersion liquid (A-2) and 65 parts by mass of the dispersion liquid (B-2) were used instead of 60 parts by mass of the dispersion liquid (A-1) and 40 parts by mass of the dispersion liquid (B-1).

### Example 11

An aqueous pigment dispersion and an aqueous ink for ink jet recording were obtained in the same manner as in Example 1 except that 70 parts by mass of the dispersion liquid (A-3) and 30 parts by mass of the dispersion liquid (B-2) were used instead of 60 parts by mass of the dispersion liquid (A-1) and 40 parts by mass of the dispersion liquid (B-1).

### Example 12

An aqueous pigment dispersion and an aqueous ink for ink jet recording were obtained in the same manner as in Example 1 except that 40 parts by mass of the dispersion liquid (A-1) and 60 parts by mass of the dispersion liquid (B-3) were used instead of 60 parts by mass of the dispersion liquid (A-1) and 40 parts by mass of the dispersion liquid (B-1).

### Example 13

An aqueous pigment dispersion and an aqueous ink for ink jet recording were obtained in the same manner as in Example 1 except that 50 parts by mass of the dispersion liquid (A-2) and 50 parts by mass of the dispersion liquid (B-3) were used instead of 60 parts by mass of the dispersion liquid (A-1) and 40 parts by mass of the dispersion liquid (B-1).

### Example 14

An aqueous pigment dispersion and an aqueous ink for ink jet recording were obtained in the same manner as in Example 1 except that 60 parts by mass of the dispersion liquid (A-2) and 40 parts by mass of the dispersion liquid (B-3) were used instead of 60 parts by mass of the dispersion liquid (A-1) and 40 parts by mass of the dispersion liquid (B-1).

### Example 15

An aqueous pigment dispersion and an aqueous ink for ink jet recording were obtained in the same manner as in Example 1 except that 60 parts by mass of the dispersion liquid (A-3) and 40 parts by mass of the dispersion liquid (B-3) were used instead of 60 parts by mass of the dispersion liquid (A-1) and 40 parts by mass of the dispersion liquid (B-1).

### Comparative Example 1

An aqueous pigment dispersion and an aqueous ink for ink jet recording were obtained in the same manner as in Example 1 except that 50 parts by mass of the dispersion liquid (A-1) and 50 parts by mass of the dispersion liquid (B-4) were used instead of 60 parts by mass of the dispersion liquid (A-1) and 40 parts by mass of the dispersion liquid (B-1).

### Comparative Example 2

An aqueous pigment dispersion and an aqueous ink for ink jet recording were obtained in the same manner as in Example 1 except that 70 parts by mass of the dispersion liquid (A-2) and 30 parts by mass of the dispersion liquid (B-4) were used instead of 60 parts by mass of the dispersion liquid (A-1) and 40 parts by mass of the dispersion liquid (B-1).

### Comparative Example 3

An aqueous pigment dispersion and an aqueous ink for ink jet recording were obtained in the same manner as in Example 1 except that 50 parts by mass of the dispersion liquid (A-3) and 50 parts by mass of the dispersion liquid (B-4) were used instead of 60 parts by mass of the dispersion liquid (A-1) and 40 parts by mass of the dispersion liquid (B-1).

### Comparative Example 4

An aqueous pigment dispersion and an aqueous ink for ink jet recording were obtained in the same manner as in Example 1 except that 50 parts by mass of the dispersion liquid (A-4) and 50 parts by mass of the dispersion liquid (B-1) were used instead of 60 parts by mass of the dispersion liquid (A-1) and 40 parts by mass of the dispersion liquid (B-1).

### Comparative Example 5

An aqueous pigment dispersion and an aqueous ink for ink jet recording were obtained in the same manner as in Example 1 except that 50 parts by mass of the dispersion liquid (A-4) and 50 parts by mass of the dispersion liquid (B-2) were used instead of 60 parts by mass of the dispersion liquid (A-1) and 40 parts by mass of the dispersion liquid (B-1).

### Comparative Example 6

An aqueous pigment dispersion and an aqueous ink for ink jet recording were obtained in the same manner as in Example 1 except that 50 parts by mass of the dispersion liquid (A-4) and 50 parts by mass of the dispersion liquid (B-3) were used instead of 60 parts by mass of the dispersion liquid (A-1) and 40 parts by mass of the dispersion liquid (B-1).

### Comparative Example 7

An aqueous pigment dispersion and an aqueous ink for ink jet recording were obtained in the same manner as in Example 1 except that 100 parts by mass of the dispersion liquid (A-1) was used instead of 60 parts by mass of the dispersion liquid (A-1) and 40 parts by mass of the dispersion liquid (B-1).

### Comparative Example 8

An aqueous pigment dispersion and an aqueous ink for ink jet recording were obtained in the same manner as in Example 1 except that 100 parts by mass of the dispersion liquid (A-2) was used instead of 60 parts by mass of the dispersion liquid (A-1) and 40 parts by mass of the dispersion liquid (B-1).

### Comparative Example 9

An aqueous pigment dispersion and an aqueous ink for ink jet recording were obtained in the same manner as in Example 1 except that 100 parts by mass of the dispersion liquid (A-3) was used instead of 60 parts by mass of the dispersion liquid (A-1) and 40 parts by mass of the dispersion liquid (B-1).

### Comparative Example 10

An aqueous pigment dispersion and an aqueous ink for ink jet recording were obtained in the same manner as in Example 1 except that 100 parts by mass of the dispersion liquid (A-4) was used instead of 60 parts by mass of the dispersion liquid (A-1) and 40 parts by mass of the dispersion liquid (B-1).

### Comparative Example 11

An aqueous pigment dispersion and an aqueous ink for ink jet recording were obtained in the same manner as in Example 1 except that 100 parts by mass of the dispersion liquid (B-1) was used instead of 60 parts by mass of the dispersion liquid (A-1) and 40 parts by mass of the dispersion liquid (B-1).

### Comparative Example 12

An aqueous pigment dispersion and an aqueous ink for ink jet recording were obtained in the same manner as in Example 1 except that 100 parts by mass of the dispersion liquid (B-2) was used instead of 60 parts by mass of the dispersion liquid (A-1) and 40 parts by mass of the dispersion liquid (B-1).

### Comparative Example 13

An aqueous pigment dispersion and an aqueous ink for ink jet recording were obtained in the same manner as in Example 1 except that 100 parts by mass of the dispersion liquid (B-3) was used instead of 60 parts by mass of the dispersion liquid (A-1) and 40 parts by mass of the dispersion liquid (B-1).

### Comparative Example 14

An aqueous pigment dispersion and an aqueous ink for ink jet recording were obtained in the same manner as in Example 1 except that 100 parts by mass of the dispersion liquid (B-4) was used instead of 60 parts by mass of the dispersion liquid (A-1) and 40 parts by mass of the dispersion liquid (B-1).

### <Method for Measuring Primary Particle Diameter of Pigment>

The primary particle diameter D (nm) of the pigment (a) and the self-dispersing pigment (b) was determined in the following manner. First, an aqueous pigment dispersion having a pigment concentration of 1% by mass was dropped into a mesh with a collodion membrane, followed by drying. The surface was observed using a STEM (scanning transmission electron microscope) (JSM-7500FA manufactured by JEOL). The acceleration voltage was set to 30 kV, and the observation magnification was set to a magnification that was easy to observe depending on the observation sample in the range of 5,000 times to 200,000 times. Based on the image observed by the above method, a value obtained by measuring the particle diameter (primary particle diameter) of the minimum unit forming the pigment (a) and the self-dispersing pigment (b) at 100 points and averaging it was defined as the primary particle diameter D (an) according to the present invention.

### <Method for Measuring Volume Average Particle Diameter of Dispersion (A) and Dispersion (B)>

Dispersion liquids (A-1) to (A-4), dispersion liquids (B-1) to (B-4), and aqueous pigment dispersions of Examples and Comparative Examples, which will be described later, were each diluted 10000 times with ion-exchanged water to obtain a sample.

Then, 4 ml of the sample was placed in a cell, and the scattered light of the laser beam was detected using a Nanotrac particle size distribution analyzer “UPA150” manufactured by MicrotracBEL Corp. in an environment of 25° C., whereby the volume average particle diameter (MV) was measured.

The volume average particle diameter was measured 3 times for one sample, and the average value was calculated. The value obtained by rounding off the first decimal place of the average value was defined as the volume average particle diameter value (unit: nm) according to the matters used to specify the present invention. The measurement conditions at this time were as follows: solvent name: water, solvent refractive index: 1.333, particle permeability: absorption, density: 1.45, and particle shape: non-spherical shape.

### <Evaluation of Storage Stability Based on Change in Viscosity>

The viscosity⁰ of the aqueous pigment dispersions immediately after production obtained in Examples and Comparative Examples was measured by using Viscometer TV-20 (manufactured by Toki Sangyo Co., Ltd.) at the conditions of 25° C. and 10 to 100 rpm.

The aqueous pigment dispersion was then sealed in a polyethylene container and stored in an atmosphere at 60° C. for 28 days. Then, the viscosity¹ of the aqueous pigment dispersion after the storage was measured at the conditions of 25° C. and 10 to 100 rpm, using Viscometer TV-20 (manufactured by Toki Sangyo Co., Ltd.).

The change rate of the viscosity was calculated based on the viscosity⁰ and the viscosity¹ of the aqueous pigment dispersion, and a formula [change rate (t)=(viscosity¹/viscosity¹)×100].

A: Change rate of viscosity of aqueous pigment dispersion is less than 1.2

B: Change rate of viscosity of aqueous pigment dispersion is 1.2 or more and less than 1.7

C: Change rate of aqueous pigment dispersion is 1.7 or more

### <Printing>

The aqueous ink for ink jet recording produced by the above method was allowed to stand for 24 hours after production. Thereafter, the aqueous ink for ink jet recording was filled in a cartridge of a commercially available ink jet printer, and a print pattern having an image density setting of 100% was printed on plain paper (Plain paper High-White) and a photographic paper (HP Advanced Photo Paper).

### <Evaluation of Optical Density (OD) on Plain Paper>

After the aqueous ink for ink jet recording was printed on the plain paper, the printed matter was allowed to stand for 1 day under an ambient temperature environment.

Next, the optical density (OD) of the printed part of the printed matter was measured by using a spectrophotometer “Gretag Macbeth Spectro Scan Transmission” (X-Rite) under the conditions of a D65 light source, no filter, and a viewing angle of 2°, and the optical density was evaluated according to the following evaluation criteria.

Evaluation criteria:

A: 1.30 or more

B: 1.10 or more and less than 1.30

C: Less than 1.10

### <Gloss Evaluation on Photographic Paper>

After the aqueous ink for ink jet recording was printed on the plain paper, the printed matter was allowed to stand for 1 day under an ambient temperature environment.

Next, gloss of the printed part of the printed matter was measured by using a spectrophotometer “micro-haze plus” (BYK-Gardner) under the condition of a viewing angle of 20°, and the gloss was evaluated according to the following evaluation criteria.

Evaluation criteria:

A: 50 or more

B: 20 or more and less than 50

C: Less than 20

TABLE 1

| Pigment (a)/nm | | | | Pigment (b)/nm | | | |
|---|---|---|---|---|---|---|---|
| #2650 | #2300 | #650B | #85 | b-1 | b-2 | b-3 | b-4 |
| 13 | 15 | 22 | 40 | 14 | 23 | 25 | 40 |

TABLE 2

| Dispersion (A)/nm | | | | Dispersion (B)/nm | | | |
|---|---|---|---|---|---|---|---|
| A-1 | A-2 | A-3 | A-4 | B-1 | B-2 | B-3 | B-4 |
| 41 | 53 | 69 | 120 | 110 | 145 | 170 | 223 |

TABLE 3

| | (Primary Particle | | | | | | | |
|---|---|---|---|---|---|---|---|---|
| | Diameter of Pigment | Aqueous Pigment Dispersion | | | | | Print Evaluation | |
| | (a))/(Primary Particle | | | Volume Average | | | Plain | Gloss |
| | Diameter of Self- | Mass Ratio % | | Particle Diameler | | Storage | Paper | Paper |
| | dispersing Pigment (b)) | A | B | A + B | | Stability | OD | Gloss |
| Example 1 | 0.93 | 60 | 40 | 87 | nm | A | B | A |
| Example 2 | 0.93 | 80 | 20 | 82 | nm | A | B | A |
| Example 3 | 1.07 | 45 | 55 | 93 | nm | A | B | A |
| Example 4 | 1.07 | 20 | 80 | 97 | nm | B | A | A |
| Example 5 | 1.07 | 50 | 50 | 95 | nm | A | B | A |
| Example S | 0.57 | 60 | 40 | 121 | nm | A | A | A |
| Example 7 | 0.65 | 80 | 20 | 118 | nm | A | A | A |
| Example 8 | 0.65 | 70 | 30 | 120 | nm | A | A | A |
| Example 9 | 0.65 | 50 | 50 | 123 | nm | A | A | A |
| Example 10 | 0.65 | 35 | 65 | 128 | nm | A | A | A |
| Example 11 | 0.96 | 70 | 30 | 132 | nm | A | A | A |
| Example 12 | 0.52 | 40 | 60 | 130 | nm | A | A | A |
| Example 13 | 0.60 | 50 | 50 | 135 | nm | A | A | B |
| Example 14 | 0.60 | 60 | 40 | 131 | nm | A | A | B |
| Example 15 | 0.88 | 60 | 40 | 140 | nm | A | A | B |
| Comparative | 0.33 | 50 | 50 | 193 | nm | A | A | C |
| Example 1 | | | | | | | | |
| Comparative | 0.38 | 70 | 30 | 187 | nm | A | A | C |
| Example 2 | | | | | | | | |
| Comparative | 0.55 | 50 | 50 | 171 | nm | A | A | C |
| Example 3 | | | | | | | | |
| Comparative | 2.86 | 50 | 50 | 135 | nm | B | A | C |
| Example 4 | | | | | | | | |
| Comparative | 1.74 | 50 | 50 | 138 | nm | A | B | C |
| Example 5 | | | | | | | | |
| Comparative | 1.60 | 50 | 50 | 145 | nm | A | B | C |
| Example 6 | | | | | | | | |
| Comparative | — | 50 | 50 | 41 | nm | A | C | A |
| Example 7 | | | | | | | | |
| Comparative | — | 70 | 30 | 53 | nm | A | C | A |
| Example 8 | | | | | | | | |
| Comparative | — | 50 | 50 | 62 | nm | A | C | A |
| Example 9 | | | | | | | | |
| Comparative | — | 100 | 0 | 120 | nm | A | C | A |
| Example 10 | | | | | | | | |
| Comparative | — | 0 | 100 | 110 | nm | B | A | C |
| Example 11 | | | | | | | | |
| Comparative | — | 0 | 100 | 145 | nm | B | A | C |
| Example 12 | | | | | | | | |
| Comparative | — | 0 | 100 | 152 | nm | C | A | C |
| Example 13 | | | | | | | | |
| Comparative | — | 0 | 100 | 223 | nm | C | A | C |
| Example 14 | | | | | | | | |

1. An aqueous pigment dispersion comprising an aqueous medium, a dispersion (A), and a dispersion (B),
wherein the dispersion (A) contains a pigment (a) and a pigment dispersant resin, and has a volume average particle diameter of 40 nm or more and less than 70 nm, and
wherein the dispersion (B) contains a self-dispersing pigment (b), and has a volume average particle diameter of 70 nm or more and 210 nm or less.

2. The aqueous pigment dispersion according to claim 1, wherein the ratio of the primary particle diameter of the pigment (a) to the primary particle diameter of the self-dispersing pigment (b) [primary particle diameter of the pigment (a)/primary particle diameter of the self-dispersing pigment (b)] is in the range of 0.5 to 1.5.

3. The aqueous pigment dispersion according to claim 1, wherein the mass ratio of the dispersion (A) to the dispersion (B) [dispersion (A)/dispersion (B)] is in the range of 0.25 to 4.0.

4. The aqueous pigment dispersion according to claim 1, wherein the pigment dispersant resin is a styrene-acrylic acid copolymer.

5. The aqueous pigment dispersion according to claim 4, wherein the pigment dispersant resin has a weight average molecular weight in the range of 6000 to 25000.
